(19) United States
(12) Patent Application Publication
(10) Pub. No.: US 2007/0134513 A1
(43) Pub. Date: Jun. 14, 2007

(54) Chemiluminescent system

(75) Inventor: Keith J. Allison, Blandon, PA (US)

Correspondence Address: RATNERPRESTIA, P O BOX 980, VALLEY FORGE, PA, 19482-0980, US

(73) Assignee: Binney & Smith

(21) Appl. No.: 11/302,020

(22) Filed: Dec. 13, 2005

(51) Int. Cl. B32B 9/06

(52) U.S. Cl. 428/690; 252/301.16

(57) ABSTRACT

A chemiluminescent reactant solution and a layer containing a solid oxidizer. An embodiment of the invention has the layer containing a solid oxidizer supported by a substrate such as paper. The reactant solution includes an oxalate and a fluorescer and reacts with the oxidizer after it is applied to the oxidizer layer. A preferred embodiment of the invention includes the presence of an oxidizer activator layer.

### FIELD OF THE INVENTION

The present invention relates generally to chemiluminescence, and more particularly to a chemiluminescent system that allows a chemiluminescent solution to react on a substrate.

### BACKGROUND OF THE INVENTION

The use of chemiluminescent, or oxyluminescent, reactions to produce light without the use of electricity, is known. These reactions involve chemical components which react chemically and provide excitation of a fluorescent compound. The generation of light in this manner has been found useful in situations where it is desirable to have a source of visible light that is not electrically activated. Such situations would include places where there is no source of electricity, or for places in which the presence of electricity would be hazardous, such as near flammable materials. Still other applications have been in novelty items and toys.

Generally, these reactions involve oxalates, fluorescing dyes, and oxidizers. One known chemistry involved in the production of visible light through chemiluminescent reactions is based on the reaction of a hydroperoxide and a chemiluminescent reactant comprised of an oxalate, such as an oxalic-type anhydride, an oxalic-type ester, or an oxalic-type amide, and a fluorescer. Many such systems are known.

### SUMMARY OF THE INVENTION

The present invention provides a chemiluminescent reactant solution and a layer containing a solid oxidizer. An embodiment of the invention has the layer containing a solid oxidizer supported by a substrate such as paper. The reactant solution includes an oxalate and a fluorescer and reacts with the oxidizer after it is applied to the oxidizer layer. A preferred embodiment of the invention includes the presence of an oxidizer activator layer. With such an embodiment, the solid oxidizer is first activated and then reacted with the chemiluminescent reactant solution to cause a glowing mark. The fluorescer in the chemiluminescent reactant solution defines the glowing color seen as a result of the reaction.

A preferred embodiment consistent with that described in the preceding paragraph includes a chemiluminescent system comprising a chemiluminescent reactant solution in a delivery applicator, and a substrate supporting a first layer comprising a solid oxidizer and a second layer comprising an oxidizer activator.

### DETAILED DESCRIPTION OF THE INVENTION

The present invention comprises a paper and an applicator (such as a marker or paint system) which combine in use to provide a glow-in-the dark marking after the applicator applies its contents to the surface of the paper. More specifically, the delivery applicator delivers a reactant solution to a treated paper surface to react with the contents of the treated surface in a chemiluminescent reaction to produce light in the region of the marking. A preferred embodiment of the invention includes a marker ink solution comprised of fluorescers and an oxalate in a suitable solvent. Although some fluroescers have a natural, or “daylight” color, some do not, and so a preferred embodiment also includes a non-luminescing dye to impart a “daylight” color to the marking ink, which might otherwise appear colorless. Generally, the fluorescers are dyes that emit light energy, or “glow,” when “charged” via energy transfer from an excited intermediate ingredient. The oxalate is the energy provider that transfers its energy to the dye through the chemical reaction.

The paper substrate includes an oxygen-providing compound, or oxidizer, such as a bleach or stable peroxide, and an oxidizer activator. The oxygen-providing compound, which can also be deemed an oxygen-releasing compound, releases oxygen during reaction with the fluorescer and oxalate. The oxygen-providing compound can take many forms, and includes common chemical bleaches such as sodium hypochlorite, chlorine bleach, and oxygen bleach, which contains hydrogen peroxide. A preferred oxygen-providing compound is a peroxide, particularly a perborate, such as sodium perborate.

The invention involves delivering the oxalate and fluorescer to the treated substrate (which in one embodiment is paper) which has at least one layer containing the oxidizer. The oxalate and fluorescer are contained essentially in solution and are preferably delivered to the treated paper via a marker (although other delivery means could be used) wielded by a user. The marker nib contacts the treated paper surface and the oxalate and fluorescer react with the oxidizer in a chemiluminescent reaction to form a “glowing” mark which can be seen by the user even when no light is otherwise present. As noted, other delivery applicators could be used, including a paintbrush, a pen, or even a user's finger.

In the preferred embodiment just described, the marker contains a solution of the oxalate and fluorescer as noted above, in addition to a solvent. A preferred solvent is a suitable oil-based solvent. In a preferred embodiment, the marker solution would also contain an additive which will give the solution a visible color when in the presence of external light so that the user can see what “color” the glowing mark will be. In such a case, the additive should provide indication of the same color as that which will be emitted upon reaction with the oxidizer, or as close a match as possible.

Such solutions (without the addition of a visible color indicator) are known, such as the system disclosed in U.S. Pat. No. 5,931,383, which is incorporated by reference herein. That patent discloses a yellow chemiluminescent system, with what it calls the “oxalate” component and the “activator” component. The oxalate component is disclosed as including dibutyl phthalate, bis(2,4,5-trichloro-6-carbopentoxyphenyl)oxalate as the oxalate, and 1-chloro-9,10-bis(phenylethynyl)anthracene as the fluorescer. In that patent, the activator component is the oxidizing composition and includes dimethyl phthalate, T-butyl alcohol, hydrogen peroxide, and sodium salicylate. That patent discloses simply mixing the two components to form a glowing yellow light.

The present invention, however, involves the application of the marker solution (plus preferably the visible light indicating dye as discussed above) on a substrate. The substrate provides the oxidizing component. When the solution is laid down on the substrate, the chemiluminescent reaction occurs as the oxalate and fluorescer in the marker solution react with the oxidizer on the substrate. It has been found, however, that the reaction is weak. The present invention solves that problem by providing an activator for the oxidizer in a layer on the treated substrate adjacent the oxidizer layer. When the marker solution contacts the treated substrate, the oil in the marker solution allows for the contacting of the oxalate, fluorescer, oxidizer, and oxidizer activator to produce a more vigorous reaction (as compared to the same reactant system without the activator) and the “glowing” mark appears. Moreover, the oxidizer is activated and the reaction with the oxalate occurs, creating a high-energy intermediate that transfers its energy to the fluorescers, causing them to emit visible light of a color defined by the particular fluorescer.

The oxidizer activator can be disposed in a layer on the treated substrate either above or below (or both) the oxidizer layer. It is important that the activator not be mixed with the oxidizer for long periods of time before the reaction occurs or the activation of the oxidizer will occur prematurely. Thus, by disposing each in a different layer, they only mix after the “ink” (which comprises the oxalate and fluorescer) is applied by the marker (or paint or other applicator). At that time, the reactants all mix, including the activator, and the chemiluminescent reaction occurs to provide the glowing mark.

A preferred oxidizer activator for use in the present invention is tetra acetyl ethylene diamine (TAED). TAED works to activate the bleaching reaction at ambient temperatures (like room temperature), and also acts to enable bleaching under milder pH conditions to produce a stronger oxidant than without the activator. The activator allows for oxidation to occur with an oxidizer that is otherwise stable until activated. For example, perborates are oxygen-releasing materials that only have effective bleaching activity at relatively high temperatures (compared to room temperature), for example 60° C. in an aqueous system. In contrast, other oxygen sources like percarbonate readily liberate oxygen in water, but such sources are not suitable for the present invention because they are not stable in air, water, or at higher temperatures. It is the combination of activator and oxidizer which works in the present invention to insure proper and controlled timing of the oxidizing reaction.

Many bleach activators include carboxylic acid esters or amides. Typically, in an aqueous system, anions of hydrogen peroxide react with the ester or amide to generate a corresponding peroxyacid. A preferred activator enhances the reaction by reacting with perborate to release hydrogen peroxide. In addition to TAED, nonanoyloxybenzene sulfonate (NOBS) will work in the present invention.

Preferred oxalate and fluorescer solutions are available from Omniglow Corp., and are available in many colors. These mixtures are known to Omniglow Corp. and are available from Omniglow Corp. As noted above, in some cases, these oxalate and fluorescer solutions are combined with a visible color additive, such as a dye, to give the “ink” a color in daylight.

The invention includes a substrate coated with at least a peroxide layer. In such an embodiment, the applicator sets down the oxalate/fluorescer solution which reacts with the peroxide layer to form a glowing mark on the substrate. As noted above, however, where a stronger and/or longer-lasting reaction is desired, it may be necessary to include a second layer, in addition to the peroxide layer, which second layer includes an oxidizer activator.

Thus a preferred embodiment includes a substrate of paper, as noted above, to which is applied at least two layers. One layer contains the oxidizer, and the other layer contains the oxidizer activator. In such an embodiment, the first layer would comprise an organic peroxide which could be laid down in an aqueous solution containing a binder resin (so it adheres, or “sticks” to the paper—one example is polyvinyl pyrollidone). The top layer could then be laid down after the first layer dries and would contain the activator.

In some instances, depending in part on the material comprising the substrate, as well as the printing process used, multiple layers of the same composition may be layed down, with each one being allowed to dry before application of the next. This is because typical printing processes deliver many tiny dots of the coating on the paper. This creates a hill-and-valley topography. Printing a single thicker layer only increases the size of the mountains, creating an uneven coating across the paper. By applying multiple layers, such as two, (one overtop the other), and because the dots seldom fall in the exact same spot as they did with the first coat (natural offset), a smoother application of the layers, with a more even distribution of dots, occurs across the substrate.

Still another preferred embodiment comprises treating a paper substrate with three layers total, with the first two coats having the oxidizer layer followed by a coat of the activator layer. In this preferred embodiment, the first two layers applied to the paper comprise organic peroxide, which, as above, is laid down in an aqueous solution. The second oxidizer layer is laid down after the first oxidizer layer is dry. This double-layering in effect allows for an increased presence of the perborate. The third and outer layer is then applied, after the second layer dries, and contains an activator such as TAED. The following TABLE I illustrates the amounts of each ingredient in this preferred embodiment. In this example, each layer was applied individually and allowed to dry between each coating step.

TABLE I

| | |
|---|---|
| Layers 1 and 2 - Oxidizer | 70.8 wt % water |
| layers, laid | 15 wt % sodium perborate |
| down separately | 12 wt % % polyvinyl pyrollidone as binder |
| | resin [ISP] |
| | 2 wt % dispersant [Surfynol CT-171 from |
| | Air Products & Chemiclas, Inc.] |
| | 0.2 wt % biocide [Acticide GA from Acti- |
| | Chem] |
| Layer 3 - Activator | 62.3 wt % water |
| | 10.5 wt % polyvinyl pyrollidone as binder |
| | resin [ISP] |
| | 25 wt % TAED |
| | 2 wt % dispersant [Surfynol CT-171 from |
| | Air Products & Chemiclas, Inc.] |
| | 0.2 wt % biocide [Acticide GA from Acti- |
| | Chem] |

Still yet another embodiment includes a system having five layers disposed on a substrate of paper. In this preferred embodiment, a first layer applied to the paper comprises an activator, which is laid down in an aqueous solution containing polyvinyl pyrollidone and TAED. Second and third layers are then applied, each containing an organic peroxide, such as sodium perborate. The fourth layer is then applied which is comprised of the activator again. The top layer, or coating layer, is a barrier overcoat, and crosslinks with the perborate layer. It preferably comprises a polyvinyl acetate. In this embodiment, the presence of the coating layer prolongs the flowing effect as compared to the same system without the coating layer. This is due to the fact that a typical capillary marker will deliver a thin film that reacts relatively quickly to produce a bright glowing mark. To slow the reaction, which may in come cases be preferred, the coating layer is provided which slows the ink penetration through the layers and extends the overall glowing effect over time. The following Table II illustrates the amounts of each ingredient in this preferred embodiment. In this preferred embodiment, each layer is coated individually and allowed to dry between each coating.

TABLE II

| | |
|---|---|
| Layer 1 - | 49.8 wt % water |
| Activator | 3 wt % polyvinyl pyrollidone as binder resin [ISP] |
| | 15 wt % TAED |
| | 30 wt % filler [Permont SC-20, which is a 20% clay |
| | dispersion in water, offered through Southern Clay |
| | Products] |
| | 2 wt % dispersant [Surfynol CT-171 from Air Products |
| | & Chemiclas, Inc.] |
| | 0.2 wt % biocide [Acticide GA from Acti-Chem] |
| Layers 2 and 3 - | 70.8 wt % water |
| Oxidizer | 15 wt % sodium perborate |
| layers, laid | 12 wt % % polyvinyl pyrollidone as binder resin [ISP] |
| down separately | 2 wt % dispersant [Surfynol CT-171 from Air Products |
| | & Chemiclas, Inc.] |
| | 0.2 wt % biocide [Acticide GA from Acti-Chem] |
| Layer 4 - | 62.3 wt % water |
| Activator | 10.5 wt % polyvinyl pyrollidone as binder resin [ISP] |
| | 25 wt % TAED |
| | 2 wt % dispersant [Surfynol CT-171 from Air Products |
| | & Chemiclas, Inc.] |
| | 0.2 wt % biocide [Acticide GA from Acti-Chem] |
| Layer 5 - | 64.8 wt % water |
| Barrier | 0.2 wt % biocide [Acticide GA from Acti-Chem] |
| | 35 wt % PVA solution [Celvol 23-204 from Celanese] |

The above examples are illustrative of two particular embodiments of the present invention. In each case, each oxidizer layer could comprise 3-93 wt % water (before it is dry), 1-95 wt % perborate, 5-15 wt % binder resin, optionally up to 2 wt % dispersant, and optionally a biocide up to 1 wt %. The activator layer(s) can comprise 3-94.5 wt % water, 5-65 wt % binder resin, 0.5-95 wt % activator (preferably TAED), optionally up to 2 wt % dispersant, and optionally a biocide up to 1 wt %. In an embodiment using the barrier layer, that layer should be layed down while comprising 10-95 wt % water, 5-90 wt % polyvinyl alcohol, and optionally up to 3 wt % biocide.

Of course, substrates other than paper could be used with the present invention, so long as suitable adhesion is achievable between the substrate and the first layer of the treatment. Examples of other substrates could be the surface of a three-dimensional object, such as a model, figurine or toy.

It is also noted that the exact order of layers is not necessarily critical to the performance of the invention. It could be envisioned that a single peroxide layer is applied. Where relatively intense development of chemiluminescence is desired, however, at least one activator layer should be disposed above the oxidizer layer(s) so the activator is picked up by the laid-down mark (and therefore the oxalate/fluorescer solution) before it gets to the oxidizer layer where the reaction then occurs.

In another embodiment of the invention, the substrate containing the oxidizer could be the paper itself if perborate (such as sodium perborate) is used in the making of the paper and thus embedded therein. In such a case, the perborate-containing paper would be coated with the activator layer and the perborate-containing paper would have to be porous enough to allow contact between the perborate and other reactants at the time of the application of the mark.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A chemiluminescent system comprising:
a chemiluminescent reactant solution; and
a layer containing a solid oxidizer.

2. The system of claim 1 wherein the layer containing a solid oxidizer is disposed on a substrate.

3. The system of claim 1 further comprising a second layer containing an oxidizer activator, the second layer disposed adjacent the layer containing a solid oxidizer.

4. The system of claim 1 wherein the solid oxidizer comprises an organic peroxide.

5. The system of claim 1 wherein the solid oxidizer comprises a perborate.

6. The system of claim 1 wherein the layer containing a solid oxidizer is disposed on a substrate of paper.

7. The system of claim 3 wherein the oxidizer activator comprises one or both of tetra acetyl ethylene diamine or nonanoyloxybenzene sulfonate.

8. The system of claim 1 wherein the chemiluminescent reactant solution comprises an oxalate and a fluorescer.

9. The system of claim 3 wherein the second layer is disposed atop the layer containing a solid oxidizer.

10. The system of claim 9 further comprising a barrier layer disposed on the side of the second layer opposite the layer containing a solid oxidizer.

11. A chemiluminescent system comprising:
a chemiluminescent reactant solution in a delivery applicator; and
a substrate supporting a first layer comprising a solid oxidizer and a second layer comprising an oxidizer activator.

12. The system of claim 11 wherein the solid oxidizer comprises an organic peroxide.

13. The system of claim 11 wherein the solid oxidizer comprises a perborate.

14. The system of claim 11 wherein the substrate is paper.

15. The system of claim 11 wherein the oxidizer activator comprises one or both of tetra acetyl ethylene diamine or nonanoyloxybenzene sulfonate.

16. The system of claim 11 wherein the chemiluminescent reactant solution comprises an oxalate and a fluorescer.

17. The system of claim 11 further comprising a barrier layer disposed on the side of the oxidizer activator layer opposite the oxidizer layer.
